(19) United States
(12) Patent Application Publication
(10) Pub. No.: US 2025/0022100 A1
(43) Pub. Date: Jan. 16, 2025

(54) MULTI-MODAL SYNTHETIC CONTENT GENERATION USING NEURAL NETWORKS

(71) Applicant: NVIDIA Corporation, Santa Clara, CA (US)

(72) Inventors: Xianchao WU, Tokyo (JP); Scott NUNWEILER, Yokohama (JP)

(73) Assignee: NVIDIA Corporation, Santa Clara, CA (US)

(21) Appl. No.: 18/352,579

(22) Filed: Jul. 14, 2023

(51) Int. Cl. G06T 5/50; G06T 5/00

(52) U.S. Cl. CPC G06T 5/50; G06T 5/70; G06F 40/289; G06F 40/35; G06T 2207/20081; G06T 2207/20084

(57) ABSTRACT

In various examples, systems and methods are disclosed relating to systems and methods for multi-modal creative content generation using neural networks. The systems and methods can use one or more neural networks to generate outputs representative of creative and/or artistic characteristics of features indicated by input prompts. The one or more neural networks can include at least one text extension model to increase an amount of information of the input prompts. The one or more neural networks can be configured to generate high resolution outputs. The one or more neural networks can be used to implement end-to-end conversational interfaces for receiving input prompts and presenting creative and/or artistic outputs.

### BACKGROUND

Content generation systems, including machine learning models, can generate content include text, speech or other audio, and images. The content can be generated based on inputs, such as user inputs. The quality of the generated content may depend on the ability to have sufficient data available for training or otherwise configuring the machine learning models. Various forms of content, including artistic or other content for which criteria relevant to creativity may be applicable, may not have sufficient data available, making it difficult to achieve target quality criteria using machine learning models.

### SUMMARY

Embodiments of the present disclosure relate to systems and methods for multi-modal artistic content generation using neural networks, such as those that incorporate one or more creative diffusional models. Systems and methods are disclosed for generative models, including diffusion models for example, that can generate outputs in one or more modalities-for example, text, audio, speech, image, and/or video modalities-to meet quality criteria (e.g., accuracy, precision, relevance to the queries or other inputs used for prompting the neural networks to generate the outputs).

In contrast to conventional systems, such as those described above, systems and methods in accordance with the present disclosure can process the queries in various manners to more effectively generate artistic content. In one or more embodiments, the outputs can be generated in high resolution. The systems can be coupled with external data sources, including but not limited to Internet-based sources, to facilitate model retraining. The systems and methods can be implemented to provide end-to-end applications of creative diffusional models in conversational artificial intelligence (AI) interfaces.

At least one aspect relates to a processor. The processor can include one or more circuits that can receive a first prompt indicating at least one feature for a first output and at least one characteristic of the feature. The one or more circuits can determine the first output, using a neural network and based at least on the at least one feature and the at least one characteristic. The one or more circuits can maintain a representation of the first output in a storage element of the neural network. The one or more circuits can cause presentation of, using at least one of a display device or an audio output device, the first output. The one or more circuits can receive, subsequent to presenting the first output, a second prompt. The one or more circuits can determine, based at least on the representation of the first output and the second prompt, a second output.

In some implementations, the one or more circuits can determine, using a text completion model and based at least on the prompt, text data representative of the prompt, the text data having at least one of a greater length or a greater amount of information than the prompt, the text completion model updated using training data including text elements associated with completion elements longer than the text elements. The one or more circuits can determine the output, using the neural network, based at least on the text data. In some implementations, the output includes at least one of image data, audio data, text data, music data, speech data, or video data. In some implementations, the output can include a combination of synthetically generated data and pre-existing data (e.g., “control data” or “source data”) or a portion of the pre-existing data of the same format(s).

In some implementations, the one or more circuits can modify the output according to a plurality of prompts received via a conversational interface. In some implementations, the one or more circuits can determine the second output by providing a concatenation of the first output and the second prompt as input to a denoising network of the neural network.

In some implementations, the neural network is updated using a first database of first training data and a second database of second training data. The first training data can include photographic image data, and the second training data can include a plurality of artistic images, each artistic image of the plurality of artistic images being assigned at least one of an identifier of an artist of the artistic image or an identifier of a style class of the artistic image.

In some implementations, the prompt includes content of at least one modality of a plurality of modalities, the plurality of modalities comprising at least one of a text modality, a speech modality, an image modality, an audio modality, or a video modality. The output can include content of at least one output modality of the plurality of modalities different from the at least one modality of the prompt.

At least one aspect relates to a system. The system can include one or more processing units that can be used to receive a first prompt indicating at least one feature for a first output and at least one characteristic of the feature. The one or more processing units can determine the first output, using a neural network and based at least on the at least one feature and the at least one characteristic. The one or more processing units can maintain a representation of the first output in a storage element of the neural network. The one or more processing units can cause presentation of, using at least one of a display device or an audio output device, the first output. The one or more processing units can receive, subsequent to presenting the first output, a second prompt. The one or more processing units can determine, based at least on the representation of the first output and the second prompt, a second output.

In some implementations, the one or more processing units can determine, using a text completion model and based at least on the prompt, text data representative of the prompt, the text data having at least one of a greater length or a greater amount of information than the prompt, the text completion model updated using training data including text elements associated with completion elements longer than the text elements. The one or more processing units can determine the output, using the neural network, based at least on the text data. In some implementations, the output includes at least one of image data, audio data, text data, music data, speech data, or video data.

In some implementations, the one or more processing units can modify the output according to a plurality of prompts received via a conversational interface. In some implementations, the one or more processing units can determine the second output by providing a concatenation of the first output and the second prompt as input to a denoising network of the neural network.

In some implementations, the neural network is updated using a first database of first training data and a second database of second training data. The first training data can include photographic image data, and the second training data can include a plurality of artistic images, each artistic image of the plurality of artistic images assigned at least one of an identifier of an artist of the artistic image or an identifier of a style class of the artistic image.

In some implementations, the prompt includes content of at least one modality of a plurality of modalities, the plurality of modalities comprising at least one of a text modality, a speech modality, an image modality, an audio modality, or a video modality. The output can include content of at least one output modality of the plurality of modalities different from the at least one modality of the prompt.

At least one aspect relates to a method. The method can include generating, using a language model and based at least on receiving an indication of one or more features and one or more characteristics corresponding to the one or more features, an expanded representation of the one or more features and the one or more characteristics, the expanded representation comprising text data. The method can include generating, by a diffusion model based at least on the text data of the extended representation, an output comprising image data representative of the extended representation. The method can include causing, using at least one of a display or an audio speaker device, presentation of the output.

In some implementations, the method includes generating the text data to have at least one of a greater length or a greater amount of information than the indication. In some implementations, the output includes at least one of audio data, text data, music data, speech data, or video data, such as data of a modality different from the indication of the one or more features and one or more characteristics.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for machine learning models for generating differentially private content are described in detail below with reference to the attached drawing figures, wherein:

FIG. 1 is a block diagram of an example machine learning model system, in accordance with some embodiments of the present disclosure;

FIG. 2 is a block diagram of an example prompt extension process, in accordance with some embodiments of the present disclosure;

FIG. 3 is a set of images generated using an example machine learning model system, in accordance with some embodiments of the present disclosure;

FIG. 4 is a flow diagram of an example of a method for creative content generation, in accordance with some embodiments of the present disclosure;

FIG. 5 is a block diagram of an example content streaming system suitable for use in implementing some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to content generation using neural networks, including for generating content to represent artistic or other creative features, such as styles of images or audio representing artistic qualities indicated by user input. This can include, for example, generating various modes of content based on various modes of input, such as to determine text, image, video, and/or audio content (or combinations thereof) from text, image, video, and/or audio inputs.

Some generative model systems, such as latent diffusion models, can generate content from inputs, including generating photo-like images from text inputs. However, it can be difficult to generate content that meets qualitative or artistic criteria, such as to generate content that represents artistic features reminiscent of or characterizable as particular artistic styles or genres, or that represents conceptual inputs that may not be directly associated with object classes or categories. For example, while some diffusion models may be configured to generate content that can be presented as photos of objects (e.g., vehicles), it may be difficult for diffusion models to generate content that represents non-object concepts, or to represent the same or similar objects with different artistic styles depending on requests represented by inputs. In addition, while relatively large datasets may be available for images or other media representations of objects, the availability of data for artistic concepts may be relatively sparse, which can make it difficult to rely on existing training approaches to configure machine learning models to be capable of generating artistic content.

Systems and methods in accordance with the present disclosure can provide machine learning models, such as diffusion models, in an architecture that can be capable of generating content in various modes of content (e.g., text, audio, images, video, etc.) that effectively represents styles or other artistic qualities requested via inputs to the models. The system can include one or more diffusion models (e.g., denoising diffusion probabilistic models), which can be configured (e.g., trained, updated) using training data to which noise is applied and modifying the diffusion models to recover the original training data from the noisy training data. The system can implement the diffusion models (or portions of the neural network architecture coupled with the diffusion models) including approaches such as variational autoencoder generative adversarial networks (GANs), such as with KL-divergence; U-Nets with cross-attention; and denoising diffusion implicit models.

The system can perform extension operations, such as textual condition extension, on the inputs (e.g., prompts) provided to the diffusion models to allow the diffusion models to more effectively generate content representative of non-tangible features, such as conceptual features. For example, the system can provide the inputs to a first generative model to determine an extended input, and then provide the extended input to the diffusion models. As an example, the system can receive a text input representing one or more features requesting image content to generate, and provide the text input to a generative model, such as a GPT, T5, or BERT model, to cause the generative model to determine the extended input, which may be a longer text string (e.g., greater number of tokens) than the text input. The generative model can be configured using various forms of training data, such as encyclopedia databases that may associate titles with content, allowing the generative model to incorporate multiple terms relevant to the text input into the extended input. This can provide the diffusion models with a greater amount of input to rely on in order to generate content.

The system can perform various pre-and post-processing operations on the generated content, such as upscaling or resolution scaling. The system can perform targeted training and retraining on artistic datasets, such as to fine tune the diffusion models using artistic datasets (e.g., including jointly fine tuning the diffusion models and text generation/extension models).

The system can maintain (e.g., in a local memory structure of the network architecture) a representation of inputs and outputs of a multiple iteration content generation session with a user. This can allow the system to be more responsive to feedback from users during iterations of the content generation session.

The systems and methods described herein may be used for a variety of purposes, by way of example and without limitation, for synthetic data generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as systems for performing conversational AI operations, systems implementing one or more language models-such as large language models (LLMs) that process textual, image, sensor, audio, and/or other data types, systems for performing synthetic data generation operations, automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems implemented at least partially in a data center, systems for performing light transport simulation, systems for performing collaborative content creation for 3D assets, systems implemented at least partially using cloud computing resources, and/or other types of systems.

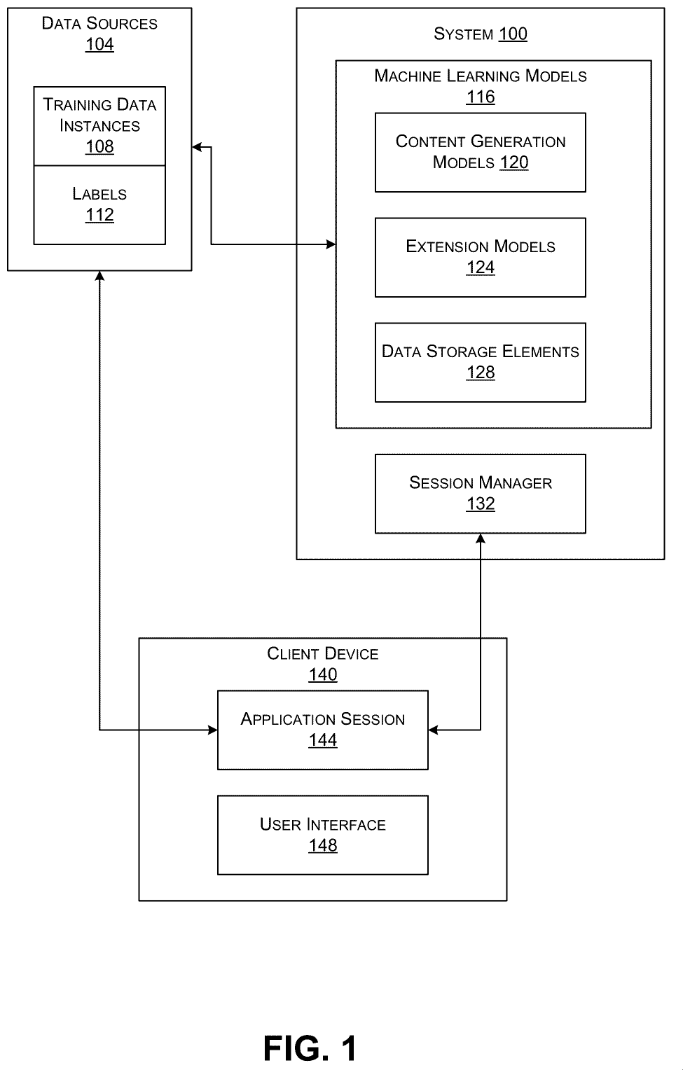

FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine learning model), operation, routine, logic, or instructions to perform functions such as configuring and/or operating machine learning models 116 as described herein.

The system 100 can perform operations using data from one or more data sources 104. The data sources 104 can include any of a variety of electronic data sources, such as electronic databases that may represent information in any of various structured, semi-structured, or unstructured data formats. The data sources 104 can include or otherwise represent content (e.g., text, speech, audio, image, and/or video data) that can be used to train various machine learning models, including but not limited to photographic, artistic, and/or musical content data. The data sources 104 can include various data sources that may be from various sources (e.g., various databases or data archives), including for representing content transferred to electronic storage formats (for example and without limitation, photographs of paintings; musical recordings, etc.) or in native electronic formats (e.g., generated using image generation software or music generation software). The data sources 104 can be maintained by one or more entities, which may be entities that maintain the system 100 or may be separate from entities that maintain the system 100. In some implementations, the system 100 can include a training system that uses training data from different data sets, such as by using data from a first data source 104 to perform at least a first configuring of the machine learning model 116, and using data from a second data source 104 to perform at least a second configuring of the machine learning model 116. For example, the first data source 104 can include publicly available data, while the second data source 104 can include data having at least some privacy or access restrictions. In some implementations, at least one data source 104 includes photographic and/or cinematographic data, at least one data source 104 includes artistic images assigned (e.g., as labels 112) at least one of an identifier of an artist of the artistic image or an identifier of a classifier of a style of the artistic image, and at least one data source 104 includes music data assigned at least one of an identifier of a musician of a musical piece of the music data or an identifier of a classifier of a style of the musical piece.

The data sources 104 can include one or more training data instances 108 (e.g., training data elements). The training data instances 108 can include, without limitation, text, speech, audio, image, and/or video data. The system 100 can perform various pre-processing operations on the training data instances 108, such as filtering, normalizing, compression, decompression, upscaling or downscaling, cropping, and/or conversion to grayscale (e.g., from image and/or video data of the training data instances 108). Images (including video) of the data of the training data instances 108 can correspond to at least one of images of a subject, such as a person or object, captured by an image capture device (e.g., camera), or images generated computationally (which may be representative of a subject, including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof.

In some implementations, the training data instances 108 include data (e.g., images) representative of artistic, musical, or other creative content. In some instances, the availability of data representative of creative content may be relatively low compared with typical data used for configuring machine learning models 116. For example, the number of paintings available in publicly available data sources, such as Wikiart, may be less than two thousand for any of the top thirty artists having available paintings. As such, it can be difficult to compile sufficient data to configure the machine learning models 116 using such data (without even taking into account considerations regarding accounting for variations of characteristics of each individual artist's creations).

In some implementations, at least one training data instance 108 is associated with one or more labels 112. For example, labels 112 can be assigned to training data instances 108 in the data sources 104. The labels 112 may correspond to at least one of user input or automated labeling of data of the training data instances 108.

The labels 112 may indicate identifiers of features represented by the training data instances 108, such as creators (e.g., authors, painters, musicians, writers, artists, etc.), sources, categories, classifications or classes of styles and/or objects represented by the data, or semantic context of text or speech data. For example, the labels 112 may represent semantic identifiers such as artistic styles, eras, movements (e.g., cubism, pointillism, etc.), or various combinations thereof. In some implementations, the training data instances 108 are retrieved from the respective data sources 104 having labels 112 assigned to the data (e.g., images) of the training data instances 108. In some implementations, the system 100 provides the data to one or more manual and/or algorithmic labelers to assign the labels 112 to the training data instances 108.

Referring further to FIG. 1, the system 100 can configure (e.g., train, update, fine-tune, perform transfer learning on) one or more machine learning models 116. The machine learning model 116 may include one or more neural networks. The neural network can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating estimated outputs of the neural network (e.g., estimated outputs can be outputs determined by the neural network responsive to receiving training data instances 108 as inputs during a training or other configuration process). The system 100 can include (e.g., one or more components to apply) various optimization processes, including but not limited to gradient descent or Adam optimization, to update the machine learning models 116 and/or the neural network(s) thereof responsive to the evaluation of the estimated outputs using one or more objective functions or loss functions. To perform transfer learning and/or fine-tuning operations, the system 100 can retrieve or otherwise identify (a first instance of) a given machine learning model 116, freeze (e.g., maintain values of) one or more weights, biases, or parameters of one or more layers of the given machine learning model 116 (e.g., an output layer), and perform training of the given machine learning model while the parameters are frozen (e.g., using training data instances 108 selected for fine-tuning and/or transfer learning).

The machine learning models 116 can be or include various neural network models, including models that are effective for operating on or generating data including but not limited to text or speech data, such as natural language representations, audio data, image data, video data, or various combinations thereof. The machine learning model 116 can include one or more transformers, recurrent neural networks (RNNs), long short-term memory (LSTM) models, language models (e.g., large language models (LLMs)), other network types, or various combinations thereof. The RNNs can use internal state data to process inputs of various lengths, including natural language data representations, such as using outputs of nodes to affect subsequent inputs to those nodes. The LSTMs can have gating elements to facilitate retaining values of data in memory over various iterations of operation of the LSTMs. The machine learning models 104 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof.

For example, the machine learning models 116 can include at least one diffusion model. The diffusion model can include a latent diffusion model, continuous time diffusion model, a stable diffusion model, a denoising diffusion probabilistic model, a denoising diffusion implicit model, or various combinations thereof. The diffusion model can include a network, such as a denoising network. For example, in brief overview, the diffusion model can include a network that is trained, updated, and/or configured using training data that includes data elements to which noise is applied, and configuring the network to modify the noise-augmented data elements to recover the (un-noised) data elements. By configuring at least one machine learning model 116 as a diffusion model to process text inputs (e.g., directly and/or using extension model(s) 124 or other models or functions that convert inputs of any of a variety of modalities into inputs for which the machine learning models 116 are configured), the machine learning models 116 can generate outputs of different modalities than the inputs provided to the machine learning models 116, including but not limited to generating video data (which may include images and audio) from text inputs.

Referring further to FIG. 1, the system 100 can sample one or more data points xo corresponding to one or more given training data instances 108 from the data sources 104 (e.g., sample x₀ from q(x) (x₀˜q(x), where q(x) represents a distribution of data from the data sources 104). The system 100 can configure the machine learning model 116 by applying noise to x₀ (e.g., performing a diffusion process) to generate one or more modified data, such as noise-augmented samples x₁, . . . X_{T} (e.g., to form a sequence of training data together with the initial sample x₀), and modifying the machine learning model 116 to meet one or more criteria associated with (i) outputs of the machine learning model 116 generated responsive to receiving the modified data as input and (ii) the data point x₀. In some implementations, the amount of noise used to modify the sample x₀ can be represented as an amount of time (e.g., a number of discrete time steps) that noise is applied to the sample.

The system 100 can configure (e.g., train, modify, update, etc.) the machine learning model 116 based at least on the training data instances 108. For example, the system 100 can use various objective functions, such as cost functions or scoring functions, to evaluate estimated (e.g., candidate) outputs that the machine learning model 116 determines (e.g., generates, produces) in response to receiving the training data instances 108 as input, and performing a comparison of the estimated outputs with the data used to determine the estimated outputs. For example, the system 100 can use an objective function that performs a comparison of noise-augmented images represented by the estimated outputs with original images of the training data instances 108. The system 100 can update the machine learning model 116 responsive to the objective function, such as to modify the machine learning model 116 responsive to whether the comparison between the estimated outputs and the training data instances 108 satisfies various convergence criteria (e.g., an output of the objective function is less than a threshold output or does not change more than a predetermined value over a number of iterations; a threshold number of iterations of training is completed; the machine learning model 116 satisfies performance criteria (e.g., with respect to output quality, accuracy of a downstream classifier operating on the output of the machine learning model 116, etc.)). The objective function can include, for example and without limitation, a least squares function, an L1 norm, or an L2 norm.

For example, the system 100 can perform a forward diffusion process in which one or more instances of noise (e.g., Gaussian noise) is added to the data point x₀ (e.g., a numerical value having the same dimensions and/or structure as the data point x₀ is added to the data point x₀) to determine the modified data x₀, x₁, . . . x_{T}, such as by using a variance schedule {βtϵ(0, 1)}^{T}ₜ₌₁ for:

$$q ( {x}_{t} \vert {x}_{t - 1} ) = ( {x}_{t} ; \sqrt{1 - {β}_{t}} {x}_{t - 1} , {β}_{t} I ) \qquad ( 1 )$$

$$q ( {x}_{1 : T} \vert {x}_{0} ) := {\prod }_{t = 1}^{T} q ( {x}_{t} \vert {x}_{t - 1} ) \qquad ( 2 )$$

Given αₜ=1−βₜ and α̅=Πᵢ₌₁^{T}αᵢ, a given modified data point xₜ (e.g., to a time step t representative of an amount of noise being applied) can be expressed as:

$${x}_{r} = \sqrt{{\overline{α}}_{t}} {x}_{0} + \sqrt{1 - {\overline{α}}_{t}} {ϵ}_{t} \qquad ( 3 )$$

where ϵₜ˜ [symbol] (0, I) can have a same shape as x₀ and x₁.

The system 100 can configure the machine learning models 116 to include at least one machine learning model (e.g., neural network) p_{θ}, having parameters θ, that can perform a reverse diffusion process (e.g., for reconstructing the data point x₀ from a Gaussian noise input) represented as:

$${p}_{θ} ( {x}_{t - 1} \vert {x}_{t} ) = ( {x}_{t - 1} ; {μ}_{0} ( {x}_{t} , t ) , {\sum }_{θ} ( {x}_{t} , t ) ) \qquad ( 4 )$$

$${p}_{θ} ( {x}_{o : T} ) := p ( {x}_{T} ) {\prod }_{t = 1}^{T} {p}_{θ} ( {x}_{t - 1} \vert {x}_{t} ) \qquad ( 5 )$$

The noise and/or time-related terms associated with the machine learning model p_{θ} can be parametrized in various manners to allow for determining the parameters of the machine learning model p_{θ}. For example, an objective function (e.g., loss function) for evaluating the candidate outputs of the machine learning model p_{θ} can be defined as:

$${L}_{t} = 𝔼 [ {‖ {ϵ}_{t} - {ϵ}_{0} ( \sqrt{{\overline{α}}_{t}} {x}_{0} + \sqrt{1 - {\overline{α}}_{t}} {ϵ}_{t} , t ‖}^{2} ] \qquad ( 6 )$$

In some implementations, the system 100 can include an autoencoder, such as a variational encoder. The autoencoder can be configured (e.g., trained, updated, fine-tuned) to receive inputs (e.g., data points corresponding to training data instances 108) and encode the inputs into a latent space, such as a compressed latent space. The autoencoder (e.g., one or more neural networks of the autoencoder) can convert (e.g., compress) at least some of the data into a latent space, such as an autoencoder. For example, the autoencoder can include an encoder (e.g., neural network encoder) configured to convert the data of the training data instances 108 from a first number of dimensions to a second number of dimensions less than the first number, and/or a decoder (e.g., neural network decoder) configured to convert the converted data from the second number of dimensions to the first number of dimensions (e.g., by training the decoder using comparisons of estimated outputs of the decoder with the original data of the training data instances 108). This can allow the system 100 to perform diffusion in the latent space, such as to determine the objective function in the latent space:

$${L}_{t}^{LDM} = 𝔼 [ {‖ {ϵ}_{t} - {ϵ}_{0} ( \sqrt{{\overline{α}}_{t}} {z}_{0} + \sqrt{1 - {\overline{α}}_{r}} {ϵ}_{t} , t ‖}^{2} ] \qquad ( 7 )$$

where z₀ corresponds to the encoding of the input into the latent space.

In some implementations, the system 100 performs classifier-based guidance and/or at least some classifier-free guidance. For example, the at least one machine learning model 116 can include or be coupled with a classifier, such as a domain-specific encoder, that the system 100 can configure to determine labels 112 responsive to receiving inputs of data of the training data instances 108. The system 100 can determine an output of the classifier, such as a gradient or other data element representative of estimated class(es) from the classifier, and can apply the output to configure the machine learning model 116, such as to apply the output to the gradient produced by the machine learning model 116. In some implementations, the system 100 uses the classifier for training with the training data instances 108, and does not use the classifier for a subset of the training data instances 108. For example, for the subset of training data instances 108, the training system 100 can discard or otherwise not provide the labels 112 corresponding to the training data instances 108, or can substitute a nominal label which may indicate that for the subset of training data instances 108 that the classifier is not to be used (e.g., training is not to be performed conditioned on the labels 112).

For example, to perform condition-based image synthesis, an input y can be encoded by an encoder τ_{θ}(y) into an encoded input to be inputted to the machine learning model 116 (e.g., for the machine learning model 116 to predict or otherwise determine ϵ₀). The input y can be a predefined input, such as any or more formats of input such as text, speech, audio, image, and/or video (e.g., a layout input). The encoder τ_{θ}(y) can include at least a portion of a cross-attention mechanism of a transformer of the machine learning model 116, such as for jointly training the encoder τ_{θ}(y) and the machine learning model 116 (e.g., a U-Net of the machine learning model 116).

Referring further to FIG. 1, the autoencoder can be configured (e.g., trained, etc.) separately and/or prior to configuring the machine learning model 116. The autoencoder can be used to encode the training data instances 108 (as well as inference/runtime data processed by the machine learning model 116) into the latent space, and can be used for decoding the reconstructed z₀ into the size/space of the training data instances 108 (e.g., of x₀). In some implementations, to use the effectiveness of the inductive bias of CNNs and/or the expressivity of transformers, the encoder ε of the autoencoder and the decoder (e.g., generator) [symbol] of the autoencoder can include at least one of a ResNet block or a self-attention block.

In some implementations, one or more loss functions can be used to configure the encoder and/or the decoder, including but not limited to using multiple losses to perform adversarial training (e.g., in a GAN framework). For example, a reconstruction loss can be implemented for a vector quantized GAN framework:

$${ℒ}_{rec} = {‖ x - 𝒢 ( q ( ℰ ( x ) ) ) ‖}^{2} , \qquad ( 7 )$$

where q(⋅) can include an element-wise quantizer and/or a two-dimensional convolution network. In addition, the system 100 can use a perceptual loss, such as a learned perceptual patch similarity loss:

$$Scale ( x ) = ( x - shift ) / scale , \qquad ( 8 )$$

$${g}_{i} ( x ) = {‖ {VGG}_{i} ( Scale ( x ) ) ‖}_{2} ,$$

$${ℒ}_{per} = {\sum }_{i = 0}^{4} \{ {lin}_{i} ( {( {g}_{i} ( x ) - {g}_{i} ( \hat{x} ) )}^{2} \}$$

where \hat{x}= [symbol] (q(ε(x)), shift represents a mean vector of one or more channels of the data (e.g., image data) in the training data instances 108 (e.g., of x), scale represents a standard deviation vector of one or more channels of the data in the training data instances 108, and VGGᵢ represents an i-th layer's output tensor (e.g., having half-size down sampling shapes). In some implementations, the system 100 can include one or more losses that include a KL loss (e.g., between the diagonal Gaussian distribution from q(ε(x))=[μ; log σ²] and [symbol] (0,I):

$${ℒ}_{KL} ( ( μ , {σ}^{2} ) ‖ ( 0 , 1 ) ) = {\sum }_{c , h , w} ( {μ}^{2} + {σ}^{2} - 1 - log {σ}^{2} ) / 2 \qquad ( 9 )$$

where c is the channel number, h is the height, and w is the width of an image. The output tensor q(ε(x)) can be separated into two parts (for example and without limitation, from (6, 64, 64) to two (3, 64, 64) shape tensors) for the mean and the log of the variance of the Gaussian distribution.

The one or more losses can include GAN losses, such as:

$${ℒ}_{g} = - log ( \hat{x} ) , \qquad ( 10 )$$

$${ℒ}_{d} = Hinge ( ( x ) , ( \hat{x} ) ) = \frac{relu ( 1 - ( x ) ) + relu ( 1 + ( \hat{x} ) )}{2} \qquad ( 11 )$$

where [symbol] represents a patch-based discriminator to differentiate between real and reconstructed images.

In some implementations, the system 100 assigns weights (e.g., adaptive weights) for combining the one or more losses used for the autoencoder:

$$ℒ = {ℒ}_{rec} + {λ}_{1} {ℒ}_{per} + {λ}_{2} {ℒ}_{rec} + {λ}_{3} {ℒ}_{g} + {λ}_{4} {ℒ}_{d} \qquad ( 12 )$$

The system 100 can vary the weights [symbol] for various stages of training/configuration. In some implementations, the system 100 determines one or more weights according to a gradient of one or more losses (including losses with respect to a subset of layers of various portions of the autoencoder, such as of the decoder).

Referring further to FIG. 1, the machine learning models 116 can include one or more denoising diffusion implicit models (DDIMs). The DDIMs can represent DDPMs that may be generalized relative to DDPMs using non-Markovian diffusion processes, which may lead to the same or similar training objective, and can allow for implicit models that generate high quality samples more rapidly. For example, the machine learning model 116 can include a model:

$${x}_{t - 1} , {f}_{θ} ( {x}_{t} , t ) = DDIM ( {x}_{t} , {ϵ}_{t} , t ) \qquad ( 13 )$$

In various implementations, the system 100 can include any of various numerical or pseudo numerical methods for evaluating the DDIM, including but not limited to the Adams-Moulton method and/or the 2^{nd} order pseudo improved Euler method.

The machine learning models 116 can include at least one extension model 124. The extension model 124 can include any one or more machine learning models, rules, heuristics, algorithms, or other functions or operations to modify inputs to be provided to the machine learning models 116, such as to increase an amount of content or information of (e.g., extend) inputs. For example, the extension model 124 can receive an input and apply one or more language processing operations to the input to generate a modified input having at least one of a greater number of tokens or greater information content than the input. The extension model 124 can operate as a text completion model, such as to generate additional text to expand on text from the inputs provided to the extension model 124.

In some implementations, the extension model 124 can be used to perform textual condition extension, such as to use text (or other modalities of input data) of inputs provided to the machine learning models 116 as a prompt for generating additional content. For example, the extension model 124 can include one or more pretrained language models, including but not limited to any of various GPT (e.g., DialoGPT), BERT, and/or T5 models. The extension models 124 can be pretrained as knowledge graphs, as an example. The extension model 124 can include or be coupled with data from any of various publicly available and/or limited access data sources 104, such as Wikipedia, Wikiart, or other encyclopedic data sources (for example and without limitation, any of various data sources that may relate concepts to descriptions or definitions of the concepts), as knowledge bases for configuring the extension model 124. In some implementations, the one or more pretrained language models of the extension model 124 are configured using training data that includes text elements (e.g., representative of inputs) and completion elements (e.g., representative of outputs) that are longer than the text elements (e.g., more information, greater number of tokens), which can allow the system 100 to configure the language models to expand on text inputs.

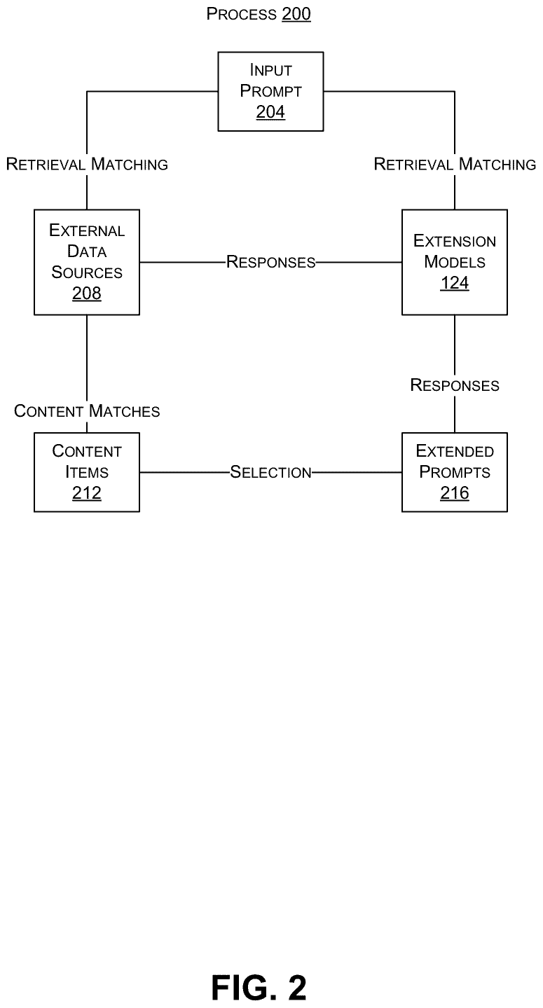

For example, as depicted in FIG. 2, the extension model 124 can perform a process 200 in which the extension model 124 performs a search (e.g., lookup, title search, etc.) in one or more external data sources 208 (e.g., Wikipedia, etc.) according to at least one input prompt 204. Responsive to performing the search, the extension model 124 can retrieve, from the external data sources 208, one or more first items of content 212 that match the input prompt 204. In some implementations, the extension model 124 can apply the input prompt 204 as input to any one or more models of the extension model 124, including but not limited to at least one of a GPT model or a T5 model (e.g., in sequence or in parallel, or various combinations thereof to any one or more extension models 124) to cause the extension model 124 to generate one or more responses to the input prompt 204. As depicted in FIG. 2, the extension model 124 can perform at least one of (i) using the responses generated by the extension models 124 to retrieve one or more second items of content that match the responses from the external data sources 208 or (ii) using the responses as at least a subset of extended prompts 216 (e.g., for further processing by the machine learning models 116). As such, the extension model 124 can generate one or more extended prompts 216 from the input prompt 204, which can facilitate more effective generating of content by the machine learning models 116.

As an example, the system 100 can receive input prompt 204 (e.g., from application session 144 as described further below) that includes text indicative of instructions to “paint an image of the economy of California in the style of Monet.” In some instances, it may be difficult for generative models such as the machine learning models 116 to have sufficient training on, or otherwise be configured to generate outputs meeting quality/fidelity criteria relative to inputs indicative of, each of (1) conceptual features as such as “economy” (or the relationship between economy and California) and (2) artistic features such as the “style of Monet.” For example, as noted above, there may be less than 1500 training data instances 108 available associated with the artist Monet; there may be few or zero training data instances 108 available that explicitly depict the “economy of California.” By providing the input prompt 204 to the extension models 124, the system 100 can generate additional text content that is related to the input prompt 204 (e.g., “The economy of California includes a wide variety of goods and services from fruit and vegetable agriculture to wineries to software engineering”), adding details to the input prompt 204 that are sufficiently related to the input prompt 204 to allow the machine learning models 116 to effectively process the extended prompts 216 for generating outputs that meet the criteria of the input prompt 204.

In some implementations, as depicted in FIG. 2, the extension model 124 can perform any of various natural language processing operations on the content items 212 (e.g., the first items of content 212 and/or the second items of content 212 retrieved from the external data sources 208), including but not limited to selecting, ranking, prioritizing, or filtering the content items 212. For example, the system 100 can determine an importance score regarding one or more portions of the content item(s) 212 (e.g., using a term frequency and inverse document frequency (TFIDF) model, etc.) to rank and/or select (e.g., by comparing the one or more portions to a threshold and/or weighting portions according to the importance scores) content items or portions thereof to include in the extended prompts 216.

In some implementations, the system 100 selects content items 212 for the extended prompts 216 according to a relationship score between the content items 212 and the input prompt 204. For example, the system 100 can determine an embedding of the input prompt 204 and content items 212 using a language model, such as T5, by determining a cosine similarity (for example and without limitation). In some implementations, the system 100 can determine the importance score as:

$$w ( v ) = TFIDF ( v ) + {λ}_{1} Cos ( T 5 ( u ) , T 5 ( v ) )$$

where λ₁ can represent a hyper-parameter for balancing the scale of the frequency-based importance detection (e.g., using the TFIDF model) and the cosine similarity-based relationship scoring. In some implementations, the system 100 can (additionally) assign a score to a given content item 212 according to an entity recognizer (e.g., named entity recognizer/detector), such as to assign value to content items 212 that include place/region names, addresses, times, and dates, which may lead to more useful information for the machine learning models 116 to process in order to generate outputs that are representative of the features indicated by the input prompts 204.

Referring further to FIG. 1, in some implementations, the machine learning models 116 can be configured to process and generate outputs (e.g., images) having relatively high resolutions, such as 2048 by 2048 pixel resolutions. For example, the machine learning models 116 can include a U-net to compress the high resolution input images into the latent space for diffusion. The high resolution representation model can be included in and/or pretrained in the variational autoencoder, and can be used with frozen weights in the stable diffusion model. In some implementations, the variational autoencoder pre-processes inputs (e.g., compresses high resolution format image inputs) to provide to the diffusion model. The variational autoencoder can post-process outputs from the diffusion model into high resolution format images.

In some implementations, the system 100 configures (e.g., trains, updates, retrains) one or more machine learning models 116 using data sources 104 such as Wikiart (which may have training data instances 108 having artistic images assigned labels 112 indicative of artists, styles, etc. of the artistic images). For example, the machine learning models 116 can include or be coupled with a tokenizer, which can include one or more models and/or natural language processing algorithms to convert (e.g., segment) a stream of text into tokens (e.g., representative of portions of words, words, phrases, sentences, etc.). In some implementations, the tokenizer includes or is part of a contrastive language-image pretraining (CLIP network, such as to allow for joint training of the tokenizer and the diffusion model of the machine learning models 116. The tokenizer (e.g., CLIP tokenizer) can encode the textual conditions represented by text inputs (e.g., responsive to segmentation into tokens) into dense representations (e.g., relatively high amounts of data per dimension of representation). By implementing various such tokenizers, the system 100 can include a more useful encoder that may provide exact textual embeddings for the diffusion model, and can improve the ability of the diffusion model to generate images that correspond to the features and/or characteristics represented by the input encoded into the text by the encoder.

The system 100 can include one or more data storage elements 128. The data storage elements 128 can store data associated with operation of the machine learning models 116. For example, the data storage elements 128 can store one or more inputs (e.g., prompts) provided to the machine learning models 116, or a representation thereof (e.g., encoded representations, compressed representations, vector representations, etc.). The data storage elements 128 can store one or more outputs (e.g., completions, images, videos, etc.) generated by the machine learning models 116, or a representation thereof (e.g., encoded representations, compressed representations, vector representations, etc.). The data storage elements 128 can store an association between the inputs and the outputs and/or concatenate the inputs with the outputs. As described further below, this can enable the system 100 to perform iterative processing of prompts received from application session 144 in an iterative (e.g., conversational AI) format, such as to receive a first input, provide the first input to the machine learning model(s) 116 to cause the machine learning model 116 to generate a first output according to the first input, receive a second input subsequent to presenting the first output, and provide the first input, the second input, and the first output as input to the machine learning model 116 to cause the machine learning model 116 to generate a second output according to the second input, the first input, and the first output.

In some implementations, the system 100 includes at least one session manager 132. The session manager 132 can manage data provided to the machine learning models 116 and/or outputted from the machine learning models 116. The session manager 132 can include or be coupled with the data storage elements 128, such as to maintain records of inputs provided to and/or outputs generated by the machine learning models 116. The session manager 132 can present requests for feedback from a user regarding outputs generated by the machine learning models 116, and use the feedback (along with the associated outputs) for updating the machine learning models 116. The session manager 132 can operate an application session 144 (described below), using the inputs and outputs iteratively received and presented using the application session 144, to iteratively modify the output according to multiple prompts received via a conversational interface of the application session 144.

The session manager 132 can operate one or more roles for machine learning models 116 for processing inputs and/or generating outputs. By incorporating roles and/or machine learning models 116 for processing inputs according to various roles (including but not limited to coupling the machine learning models 116 with various application programming interfaces (APIs) that can provide information specific to various types of inputs), the system 100 can more efficiently route requests to appropriate models for processing the inputs and updating the machine learning models 116. For example, the session manager 132 can identify one or more received inputs (e.g., requests to generate content) and store the requests in a request queue, which can allow the session manager 132 to manage processing of the inputs in various manners, including but not limited to a first-in first-out (FIFO) process. The session manager 132 can present the inputs or a portion thereof to various role-specific machine learning models 116, such as models configured to process types of data (e.g., text, image, audio, speech, video, etc.), responsive to which the machine learning models 116 can indicate that they are enabled to process inputs according to the types of data. The session manager 132 and/or the machine learning models 116 can retrieve information corresponding to data of the inputs from one or more APIs, for example and without limitation, a weather API, a time API, a speech recognition API (e.g., for detecting text from audio representing speech data), an image recognition API (e.g., to detect text and/or objects from image or video inputs), or various combinations thereof.

In some implementations, the session manager 132 controls a user interface according to one or more content request criteria, such as a number of inputs or an amount of text of inputs. For example, responsive to the number of inputs and/or amount of text of inputs (e.g., prompts) received from a user, the session manager 132 can cause the user interface to present a request for additional prompts or information from the user. This can allow the system 100 to acquire greater information to use for generating content as part of a conversational flow of prompts received from and completions provided to the user.

Referring further to FIG. 1, the system 100 can include or be coupled with at least one client device 140 that can operate one or more application sessions 144. The client device 140 can include one or more user interfaces 148, which can include various components, such as display devices, audio output devices, and/or input devices, for presenting outputs and/or receiving inputs, including to present the application sessions 144.

For example, the application sessions 144 can present fields or other user input elements for receiving prompts and presenting completions, such as text, images, and/or audio, generated by the machine learning models 116 responsive to the prompts. The application sessions 144 can receive the prompts and provide the prompts to the machine learning models 116 (e.g., using the session manager 132). The application sessions 144 can present requests for prompts and completions in a sequential manner to allow for the user interfaces 148 to have a conversational format.

The application session 144 can receive inputs (e.g., prompts, including but not limited to input prompts 204 described with reference to FIG. 2) that indicate one or more features of output for the machine learning models 116 to generate. The inputs can include any of a variety of data formats, including but not limited to text, speech, audio, image, or video data indicating instructions corresponding to the features of outputs for the machine learning models 116 to generate. For example, the inputs can indicate, for example and without limitation, features to be included in the output such as concepts (“economy,” “climate,” etc.), objects, persons, locations, times of day or year (e.g., seasons), and so forth.

The inputs can indicate one or more characteristics of the at least one feature. The characteristics can include any one or more of artists, styles, artistic periods, sources, color schemes, color palettes, examples of predefined image settings or filters, musical styles or periods, cinematography, camera settings, video camera settings, or various combinations thereof. By retrieving characteristics from the inputs and/or extending the inputs using the extension models 124, the machine learning models 116 (having been configured/trained/retrained using artistic training data) can generate outputs that represent the features and characteristics with greater quality (e.g., greater richness, relevance, accuracy, fidelity, and/or precision with respect to the features and characteristics of the inputs).

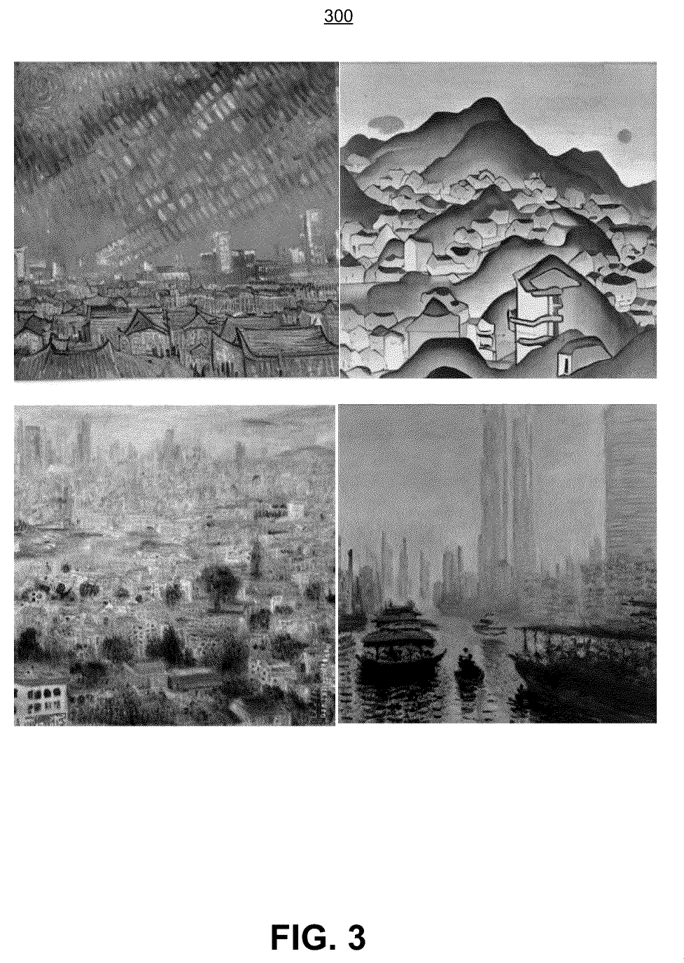

FIG. 3 depicts examples of images 300 that can be generated using various aspects of the present disclosure, such as through a conversational AI interface implemented by or using the system 100. For example, one or more of the images 300 may be generated responsive to receiving prompts indicating instructions to generate images having the features of “a painting of urbanization of China” and having characteristics of four different artists styles (e.g., upper left—van Gogh; upper right—Roerich; lower left—Renoir; lower right—Monet). By implementing various aspects of the present disclosure, the images 300 can be generated (and refined, e.g. and without limitation, using the session management and/or textual extension features described herein) to satisfy various objective and subjective criteria for the images 300, including but not limited to criteria associated with accuracy, precision, and/or fidelity with respect to the requested characteristics for the images 300, and/or computational resource usage (e.g., reducing a total number of API calls and/or model operation iterations to achieve a final output).

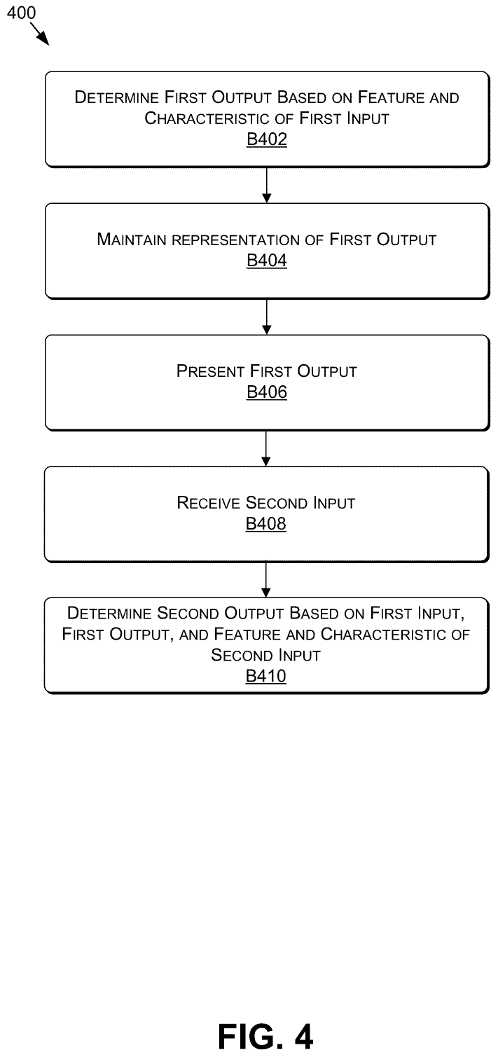

Now referring to FIG. 4, each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1 and the process of FIG. 2. However, this method may additionally or alternatively be executed by any one system, or any combination of systems, including, but not limited to, those described herein.

FIG. 4 is a flow diagram showing a method 400 for multi-modal creative content generation using neural networks, in accordance with some embodiments of the present disclosure. Various operations of the method 400 can be implemented by the same or different devices or entities at various points in time. For example, one or more first devices may implement operations relating to configuring diffusion models, and one or more second devices may implement operations relating to receive user inputs requesting content to be generated and presenting or otherwise providing the content. The one or more second devices may maintain the diffusion models, or may access the diffusion models using, for example and without limitation, APIs provided by the one or more first devices.

The method 400, at block B402, includes determining a first output according to one or more features of a first input and one or more characteristics corresponding to the one or more features. The first input (among other inputs) can be received in various formats, including but not limited to text, speech, audio, image, and/or video data. For example, the first input can indicate text instructions for incorporating the one or more features into text data, speech data, and/or image data of the output. The first input can indicate, for example, subject matter to include in the output (e.g., as content) as well as styling (e.g., artistic styles) or other formatting features of the output. The first input can be received via a user interface, which may be implemented by the same device that implements one or more machine learning models for processing the first input to determine the first output, or a separate device from the one or more machine learning models. For example, the first input may be received via a client device that communicates the input to a server device that implements the machine learning model(s).

The first output can be determined using one or more machine learning models, such as one or more diffusion models (e.g., denoising networks of diffusion models), such as DDIMs, that are configured using training data having examples of artistic or creative images, audio, and/or video. The features of the first input can represent concepts, subjects, or objects to be represented by the first output. The characteristics of the first input can include styles, classes, artistic periods, or various combinations thereof, to represent creative aspects of the first output. The denoising network can modify an initial output (which may be a randomly sampled noise data structure) into the output based at least on the one or more features and one or more characteristics of the first input.

The diffusion model can be configured using data of relatively high resolutions, including but not limited to 2048 by 2048 pixel resolutions. The diffusion model can include one or more encoders, such as variational autoencoder(s), to encode inputted data into a latent space (e.g., for performing diffusion operations, such as applying noise to the encoded data, the latent space) and decode data modified in the latent space up to the relatively high resolution. By implementing the variational autoencoder, the diffusion model can be efficiently configured while being able to provide high resolution outputs.

In some implementations, the first input is received via a conversational interface, such as an end-to-end conversational interface (e.g., an interface in which inputs and outputs can be presented in a common display and/or audio session or presentation). Various inputs may be received in an iterative manner along with outputs presented via the conversational interface (the outputs may include those generated using the diffusion models as well as other language models or natural language processing or natural language generation models or algorithms). In some implementations, the first input is further processed in a text domain prior to being applied as input to the diffusion model, such as to increase an amount of text and/or information of the input. For example, the first input can be applied as input to one or more language models or algorithms configured to generate and/or retrieve (e.g., from Wikipedia or other encyclopedic data sources) additional text data corresponding to the first input. This can allow the diffusion model to have greater information to use for generating image and/or video content.

The method 400, at block B404, includes maintaining a representation of the first output in one or more data storage elements. The data storage elements can include memory elements include in an architecture of the machine learning models, such as a latent array or other array retrieved by various layers of transformer and/or attention mechanisms of the machine learning models, or can be maintained by components separate from the machine learning models. The representation can be stored responsive to generating the first output. In some implementations, maintaining the representation includes concatenating the first output with the first input.

The method 400, at block B406, includes presenting the first output. For example, the first output can be presented using at least one of a display device or an audio output device, according to data format(s) of the first output. The first output can be presented as part of the conversational interface, such as in an inline format with text representative of inputs from a user and outputs from the machine learning models and/or a real-time audio format. In some implementations, a request for additional inputs (e.g., feedback, clarification) can be presented together with or subsequent to presenting the first output, which can allow for additional information regarding the output to be received by the machine learning models for further processing and updating the first output.

The method 400, at block B408, includes receiving a second input. The second input can be of the same or similar format as the first input (e.g., any of various text, speech, audio, image, and/or video formats). The second input can be received subsequent to presentation of the first output. The second input can indicate one or more features and one or more characteristics of a second output to be generated to represent the one or more features and one or more characteristics. In some implementations, the second input is provided to the one or more language models, which can allow for expansion of the content of the second input and/or the features and characteristics thereof. In some implementations, the second input (or a portion thereof) is concatenated to the representation of the first input and the first output.

The method 400, at block B410, includes determining a second output, using the one or more machine learning models, according to the first input (and/or the features and characteristics of the first input), the first output, and the features and characteristics of the second input. For example, the first input, first output, and second input can be applied as input to the one or more machine learning models, such as to a diffusion model, which can generate the second output according to the first input, first output, and second input. This can allow the outputs to improve over a small number of interactions (and associated data processing events, API calls, and/or processor/memory usage) with the user (e.g., to more closely align with the features and characteristics requested by the user while providing artistic and/or creative qualities to the outputs). In some implementations, various numbers of iterations of generating outputs and receiving inputs can be performed. The inputs and outputs can be used for updating the machine learning models (e.g., including with feedback received from the user indicative of whether the outputs satisfied the user's requirements for the inputs).

### Example Content Streaming System

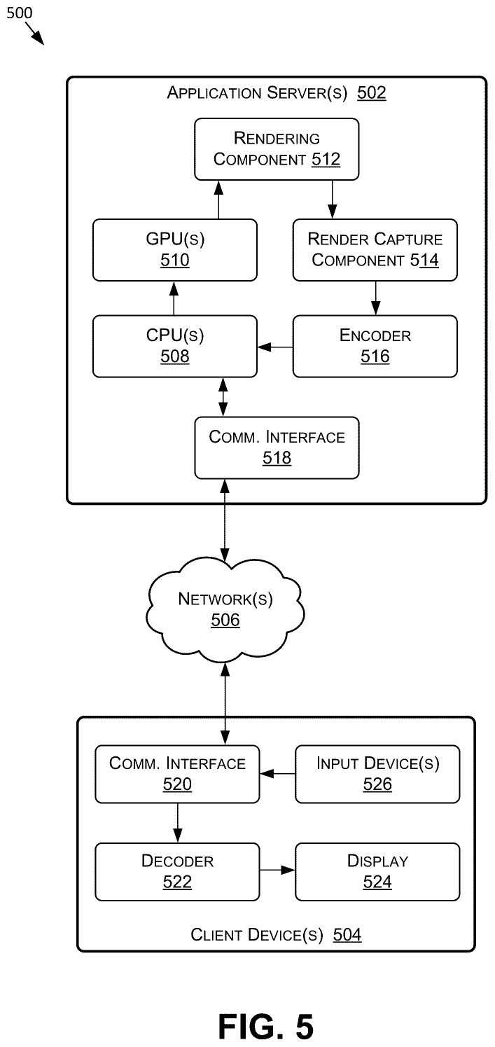

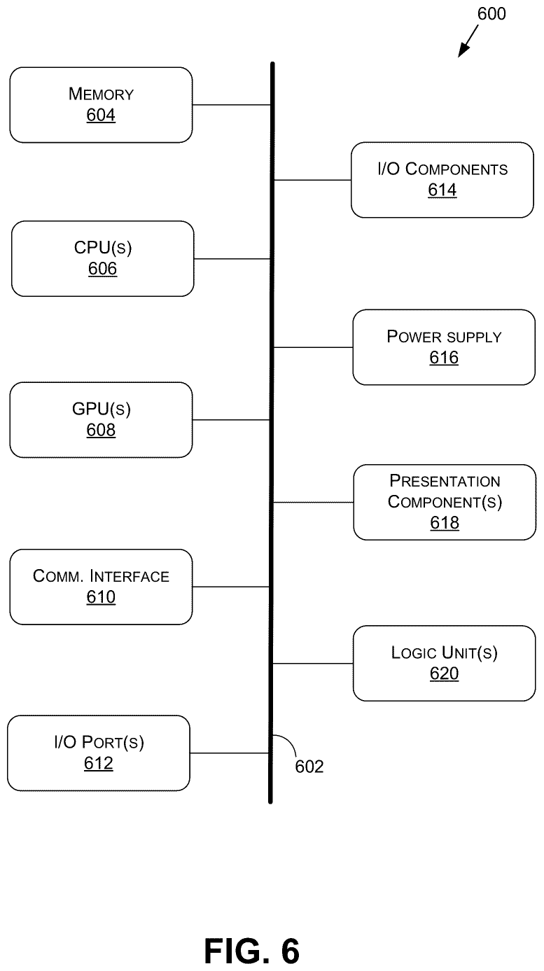

Now referring to FIG. 5, FIG. 5 is an example system diagram for a content streaming system 500, in accordance with some embodiments of the present disclosure. FIG. 5 includes application server(s) 502 (which may include similar components, features, and/or functionality to the example computing device 600 of FIG. 6), client device(s) 504 (which may include similar components, features, and/or functionality to the example computing device 600 of FIG. 6), and network(s) 506 (which may be similar to the network(s) described herein). In some embodiments of the present disclosure, the system 500 may be implemented. The application session may correspond to a conversational interface (e.g., a conversational AI interface), a chat application, a chatbot, a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 500 can be implemented to receive input indicating one or more features of output to be generated using a diffusion model, provide the input to the model to cause the model to generate the output, and present the output, including in iterative and/or conversational interfaces.

In the system 500, for an application session, the client device(s) 504 may only receive input data in response to inputs to the input device(s), transmit the input data to the application server(s) 502, receive encoded display data from the application server(s) 502, and display the display data on the display 524. As such, the more computationally intense computing and processing is offloaded to the application server(s) 502 (e.g., rendering-in particular ray or path tracing-for graphical output of the application session is executed by the GPU(s) of the game server(s) 502). In other words, the application session is streamed to the client device(s) 504 from the application server(s) 502, thereby reducing the requirements of the client device(s) 504 for graphics processing and rendering.

For example, with respect to an instantiation of an application session, a client device 504 may be displaying a frame of the application session on the display 524 based on receiving the display data from the application server(s) 502. The client device 504 may receive an input to one of the input device(s) and generate input data in response. The client device 504 may transmit the input data to the application server(s) 502 via the communication interface 520 and over the network(s) 506 (e.g., the Internet), and the application server(s) 502 may receive the input data via the communication interface 518. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 512 may render the application session (e.g., representative of the result of the input data) and the render capture component 514 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 502. In some embodiments, one or more virtual machines (VMs)—e.g., including one or more virtual components, such as vGPUs, vCPUs, etc.—may be used by the application server(s) 502 to support the application sessions. The encoder 516 may then encode the display data to generate encoded display data and the encoded display data may be transmitted to the client device 504 over the network(s) 506 via the communication interface 518. The client device 504 may receive the encoded display data via the communication interface 520 and the decoder 522 may decode the encoded display data to generate the display data. The client device 504 may then display the display data via the display 524.

The systems and methods described herein may be used for a variety of purposes, by way of example and without limitation, for language models (e.g., large language models (LLMs)), conversational interfaces, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCle link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user, such as to receive prompts for processing by the machine learning models 116, including text or image data. In some instances, inputs may be transmitted to an appropriate network element for further processing. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

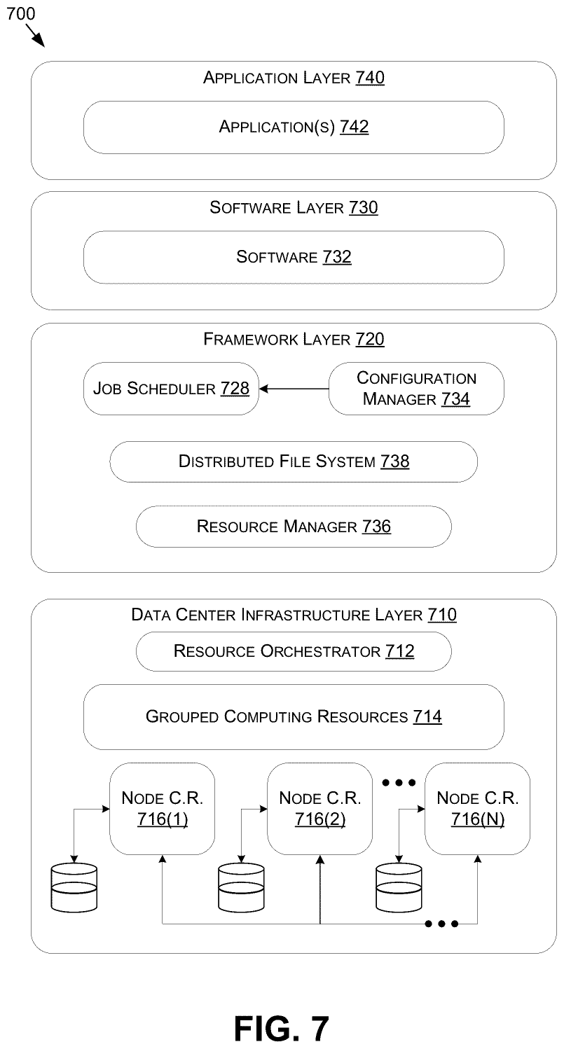

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 116.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models (e.g., machine learning models 116) or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment). The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one more circuits to:
receive a first prompt indicating at least one feature for a first output and at least one characteristic of the at least one feature;
determine the first output using a neural network and based at least on the at least one feature and the at least one characteristic;
maintain a representation of the first output in a storage element;
cause, using at least one of a display device or an audio output device, a presentation of the first output;
receive, subsequent to the presentation of the first output, a second prompt; and
determine, based at least on the representation of the first output and the second prompt, a second output.

2. The processor of claim 1, wherein the one or more circuits are to determine the first output by:
determining, using a text completion model and based at least on the prompt, text data representative of the first prompt, the text data having at least one of a greater length or a greater amount of information than the prompt, the text completion model updated using training data comprising text elements associated with completion elements longer than the text elements; and
determining the first output, using the neural network, based at least on the text data.

3. The processor of claim 1, wherein the first output comprises at least one of image data, audio data, text data, music data, speech data, or video data.

4. The processor of claim 1, wherein the one or more circuits are to iteratively modify the first output according to a plurality of prompts received via a conversational interface.

5. The processor of claim 1, wherein the one or more circuits are to determine the second output by providing a concatenation of the first output and the second prompt as input to a denoising network of the neural network.

6. The processor of claim 1, wherein the neural network is updated using a first database of first training data and a second database of second training data, the first training data comprising photographic image data, the second training data comprising a plurality of artistic images, each artistic image of the plurality of artistic images assigned at least one of an identifier of an artist of the artistic image or an identifier of a style class of the artistic image.

7. The processor of claim 1, wherein:
the first prompt comprises content of at least one modality of a plurality of modalities, the plurality of modalities comprising at least one of a text modality, a speech modality, an image modality, an audio modality, or a video modality; and
the first output comprises content of at least one output modality of the plurality of modalities different from the at least one modality of the first prompt.

8. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

9. A system comprising:
one or more processing units to receive a first prompt indicating at least one feature for a first output and at least one characteristic of the at least one feature, generate a first output using a neural network and based at least on the at least one feature and the at least one characteristic, cause a presentation of the first output determine the first output, receive a second prompt subsequent to the presentation of the first output, a second prompt, and determine a second output based at least on the second prompt and a representation of the first output in a storage element local to the neural network.

10. The system of claim 9, wherein to determine the first output, the one or more processing units are configured to:
determine, using a text completion model and based at least on the first prompt, text data representative of the first prompt, the text data having at least one of a greater length or a greater amount of information than the prompt, the text completion model updated using training data comprising text elements associated with completion elements longer than the text elements; and
determine the first output using the neural network and based at least on the text data.

11. The system of claim 9, wherein the first output comprises at least one of image data, audio data, text data, music data, speech data, or video data.

12. The system of claim 9, wherein the one or more processing units are to iteratively modify the first output according to a plurality of prompts received via a conversational interface.

13. The system of claim 9, wherein the one or more processing units are to determine the second output by providing a concatenation of the first output and the second prompt as input to a denoising network of the neural network.

14. The system of claim 9, wherein the neural network is updated using a first database of first training data and a second database of second training data, the first training data comprising photographic image data, the second training data comprising a plurality of artistic images, each artistic image of the plurality of artistic images assigned at least one of an identifier of an artist of the artistic image or an identifier of a style class of the artistic image.

15. The system of claim 9, wherein:
the first prompt comprises content of at least one modality of a plurality of modalities, the plurality of modalities comprising at least one of a text modality, a speech modality, an image modality, an audio modality, or a video modality; and
the first output comprises content of at least one output modality of the plurality of modalities different from the at least one modality of the prompt.

16. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

17. A method, comprising:
generating, using a language model and based at least on receiving an indication of one or more features and one or more characteristics corresponding to the one or more features, an extended representation of the one or more features and the one or more characteristics, the extended representation comprising text data;
generating, by a diffusion model based at least on the text data of the extended representation, an output comprising image data representative of the extended representation; and
causing, using at least one of a display or an audio speaker device, presentation of the output.

18. The method of claim 17, further comprising iteratively updating the output according to a plurality of prompts received via a conversational interface.

19. The method of claim 17, wherein generating the extended representation comprises generating the text data to have at least one of a greater length or a greater amount of information than the indication.

20. The method of claim 17, wherein the output comprises at least one of audio data, text data, music data, speech data, or video data.
